(19) United States
(12) Patent Application Publication
(10) Pub. No.: US 2026/0056746 A1
(43) Pub. Date: Feb. 26, 2026

(54) PREFETCHING FOR BLOCK MEMORY INSTRUCTIONS

(71) Applicant: Arm Limited, Cambridge (GB)

(72) Inventors: Devin S. LAFFORD, Austin, TX (US); Jacob Martin DEGASPERIS, Austin, TX (US); . ABHISHEK RAJA, Niagara Falls, NY (US)

(21) Appl. No.: 18/813,183

(22) Filed: Aug. 23, 2024

(51) Int. Cl. G06F 9/38; G06F 9/30

(52) U.S. Cl. CPC G06F 9/3802; G06F 9/30043; G06F 9/3016

(57) ABSTRACT

An apparatus comprises decoding circuitry to decode instructions defined according to an instruction set architecture, the instruction set architecture supporting a block memory instruction identifying a block of memory to which a predetermined type of memory operation is to be performed; processing circuitry to perform data processing in response to the decoded instructions; and block prefetch circuitry to generate a prefetch request, the prefetch request comprising a request for data to be prefetched into a cache; in which the block prefetch circuitry determines whether the decoding circuitry has detected the block memory instruction in a sequence of decoded instructions; and in response to determining that the decoding circuitry has detected the block memory instruction, generates a block-instruction-triggered stream of prefetch requests, each specifying a memory address between a start address and an end address of the block of memory identified by the block memory instruction.

### BACKGROUND

### Technical Field

The present technique relates to the field of data processing and in particular to prefetching data from a memory system.

### Technical Background

Some data processing apparatuses comprise prefetching circuitry for issuing prefetch requests to cause data to be prefetched into a cache in advance of an instruction explicitly requesting that data. Successfully prefetching data therefore improves performance because a load operation can therefore quickly access the requested data from the cache instead of being stalled while the requested data is being fetched from memory. Various techniques of generating prefetch requests may be used, including analysing a pattern of demand memory accesses so as to predict the address of a future demand memory access.

### SUMMARY

At least some examples of the present technique provide an apparatus comprising: decoding circuitry to decode instructions defined according to an instruction set architecture, the instruction set architecture supporting a block memory instruction identifying a block of memory to which a predetermined type of memory operation is to be performed; processing circuitry to perform data processing in response to the decoded instructions; and block prefetch circuitry configured to generate a prefetch request, the prefetch request comprising a request for data to be prefetched into a cache; in which: the block prefetch circuitry is configured to: determine whether the decoding circuitry has detected the block memory instruction in a sequence of decoded instructions; and in response to determining that the decoding circuitry has detected the block memory instruction, generate a block-instruction-triggered stream of prefetch requests, each specifying a memory address between a start address and an end address of the block of memory identified by the block memory instruction.

At least some examples of the present techniques provide a system comprising: the apparatus as described above implemented in at least one packaged chip; at least one system component; and a board, wherein the at least one packaged chip and the at least one system component are assembled on the board.

At least some examples of the present technique provide a chip-containing product comprising the system described above, wherein the system is assembled on a further board with at least one other product component.

At least some examples of the present technique provide a method comprising: decoding instructions defined according to an instruction set architecture, the instruction set architecture supporting a block memory instruction identifying a block of memory to which a predetermined type of memory operation is to be performed; performing data processing in response to the decoded instructions; generating a prefetch request, the prefetch request comprising a request for data to be prefetched into a cache corresponding to an address predicted to be accessed in future; and in response to detecting the block memory instruction, generating a block-instruction-triggered stream of prefetch requests, each specifying a memory address between a start address and an end address of the block of memory identified by the block memory instruction.

At least some examples of the present technique provide a non-transitory computer-readable medium storing computer-readable code for fabrication of an apparatus comprising: decoding circuitry to decode instructions defined according to an instruction set architecture, the instruction set architecture supporting a block memory instruction identifying a block of memory to which a predetermined type of memory operation is to be performed; processing circuitry to perform data processing in response to the decoded instructions; and block prefetch circuitry configured to generate a prefetch request, the prefetch request comprising a request for data to be prefetched into a cache corresponding to an address predicted to be accessed by the processing circuitry in future; in which: the block prefetch circuitry is configured to: determine whether the decoding circuitry has detected the block memory instruction in a sequence of decoded instructions; and in response to determining that the decoding circuitry has detected the block memory instruction, generate a block-instruction-triggered stream of prefetch requests, each specifying a memory address between a start address and an end address of the block of memory identified by the block memory instruction.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of an apparatus comprising a prefetching unit;

FIG. 2 illustrates how memory addresses may be targeted by block memory instructions;

FIG. 3 illustrates the generation of prefetch requests in response to a block memory instruction;

FIG. 4 illustrates an example apparatus comprising a block prefetcher and throttling circuitry;

FIG. 5 illustrates a sequence of steps for prefetching in response to a block memory instruction;

FIG. 6 illustrates how a size difference between a consumed portion and a prefetched portion of memory can be measured;

FIGS. 7A and 7B illustrates a sequence of steps for updating a completion counter;

FIG. 8 illustrates a sequence of steps for cancelling generation of prefetch requests;

FIG. 9 illustrates a sequence of steps for resetting a completion counter;

FIG. 10 illustrates an out-of-order window encompassing two block memory instructions;

FIG. 11 illustrates a system and a chip-containing product;

FIG. 12 illustrates a processing element; and

FIG. 13 illustrates a vector datapath.

### DESCRIPTION OF EXAMPLES

In accordance with some example embodiments, there is provided an apparatus comprising decoding circuitry to decode instructions defined according to an instruction set architecture, the instruction set architecture supporting a block memory instruction identifying a block of memory to which a predetermined type of memory operation is to be performed. When attempting to prefetch data from the block of memory, a pattern of demand memory accesses, e.g. resulting from a plurality of micro-operations, may be analysed to predict future accesses such that the data can be prefetched into a cache in advance of the micro-operation and hence accessed more quickly. However, when using this technique for prefetching, a prefetcher will continue to predict memory addresses until there has been some indication that a memory address has been mispredicted (e.g. a cache miss). This can happen for block memory instructions when the prefetcher continues to predict a pattern of memory addresses beyond the end of the block of memory, thus prefetching unnecessary data and polluting the cache. Another problem with using monitoring of a pattern of demand memory accesses as a basis for generating prefetch requests is that a certain number of demand memory accesses is required before the prefetcher can adequately recognise the pattern. For block memory instructions that specify relatively small blocks of memory, it is possible for most or all of the block of memory to have been operated on by the processing circuitry before the prefetcher has recognised the pattern, which prevents timely prefetching.

In an apparatus according to the present techniques, block prefetching circuitry is provided and configured to determine whether the decoding circuitry has detected the block memory instruction in a sequence of decoded instructions, and in response to determining that the decoding circuitry has detected the block memory instruction, generate a block-instruction-triggered stream of prefetch requests, each specifying a memory address between a start address and an end address of the block of memory identified by the memory instruction block. Since the block instruction provides an indication of the block of memory identified by the memory instruction block, the block prefetch circuitry does not need to wait to recognise a pattern of demand memory accesses. Additionally, the block prefetch circuitry may stop generating prefetch requests once the end address of the block of memory has been reached. Accordingly, the present techniques allow for more timely prefetching of a block of memory with reduced pollution of the cache with unnecessarily prefetched data.

In some examples, the block prefetch circuitry generates at least a first prefetch request of the block-instruction-triggered stream of prefetch requests before any demand memory accesses has been received from the processing circuitry in response to execution of the block memory instruction. Therefore, the prefetch requests can be generated sooner compared to other prefetching techniques that rely on an analysis of demand memory accesses.

In some examples, the block prefetch circuitry of the present techniques may be combined with pattern-analysis prefetch circuitry configured to maintain training data indicative of an observed pattern of memory accesses and generate a pattern-triggered stream of prefetch requests based on the training data. For example, such pattern-analysis prefetch circuitry may be useful for controlling prefetching of other data used by instructions other than the block memory instruction. The block prefetch circuitry described above may be given priority in respect of prefetching for the block memory instructions, hence the demand memory accesses requests received from processing circuitry executing the block memory instruction would not be useful to include the training data for the pattern-analysis prefetch circuitry. In some examples, it may be detrimental to the training data to include the demand memory access requests corresponding to the block memory instruction (as this could waste capacity in the training data storage that could be better used for making prefetch predictions for other data access patterns). Accordingly, in response to a block-instruction-triggered stream of prefetch requests being generated in respect of the block memory instruction, the pattern-analysis prefetch circuitry is configured to exclude, from the training data, demand memory access requests received from the processing circuitry in response to execution of the block memory instruction.

In some examples, other factors may inhibit the block prefetch circuitry from generating the block-instruction-triggered stream of prefetch requests in response to the block memory instruction, e.g. if a block-instruction queue (described below) is already full. The pattern-analysis prefetch circuitry may still include, in the training data, memory access requests received from the processing circuitry in response to a block memory instruction, for which prefetch requests have not been generated by the block prefetch circuitry. Additionally, the pattern-analysis prefetch circuitry still includes, in the training data, demand memory access requests received from the processing circuitry in response to execution of an instruction other than a block memory instruction. In this way, if the block prefetch circuitry is unable to generate the block-instruction-triggered stream of prefetch requests for a given block memory instruction, the pattern-analysis prefetch circuitry may be used as a backup.

It is possible for the block memory instruction to be detected by the decoding circuitry and then not executed (or not executed in full) by the processing circuitry. For example, the block memory instruction may be predicted as part of a stream of instructions after a branch. If it is then determined that the branch outcome was predicted incorrectly, the block memory instruction is flushed from the processing pipeline, meaning that data prefetched for that block memory instruction by the block prefetch circuitry will not be used. Therefore, in some examples, the block prefetch circuitry is configured to stop generating the block-instruction-triggered stream of prefetch requests in response to a flush signal indicative of the block memory instruction, or an associated block memory instruction specifying the block of memory, being flushed. For example, the associated block memory instruction could be another instruction in a sequence of multiple block memory instructions acting on the block of memory (e.g. the sequence of multiple instructions may comprise prologue, main and epilogue block memory instructions as mentioned below).

In some examples, the block prefetch circuitry comprises a block-instruction queue configured to track a plurality of blocks of memory specified by a plurality of block memory instructions detected by the decoding circuitry. Therefore, in a sequence of instructions where block memory instructions are relatively frequent, the block prefetch circuitry may buffer the information specifying each block of memory to be prefetched. Each of the plurality of the blocks of memory are then tracked in association with an identifier, such as an instruction identifier for a first block memory instruction detected specifying that particular block memory instruction. A flush signal received in respect of a particular one of the block memory instructions comprises the identifier associated with the block of memory so that the block prefetch circuitry can stop generating the block-instruction-triggered stream of prefetch requests in respect of that block memory instruction, whereas a block-instruction-triggered stream of prefetch requests for another, i.e. not flushed, block memory instruction may be continued.

In some examples, the apparatus is provided with throttling circuitry configured to enforce a maximum limit on a size difference between a prefetched portion of the block of memory that has been targeted by the block-instruction-triggered stream of prefetch requests and a consumed portion of the block of memory to which at least one demand memory access has been detected as consuming previously prefetched data. The throttling circuitry is useful, particularly where the block of memory is relatively large compared to the size of the cache, to prevent the block prefetch circuitry from completely filling the cache with prefetched data and causing other useful data to be evicted. The size difference that is limited by the throttling circuitry represents the amount of data that has been prefetched into the cache but not yet consumed by the processing circuitry.

In examples where block prefetch circuitry prefetches enough data such that the size difference reaches the maximum limit, the throttling circuitry is configured to cause the block prefetch circuitry to pause generation of the block-instruction-triggered stream of prefetch requests. While the generation is paused, the prefetched portion of the block of memory does not change, whereas the demand memory accesses by the processing circuitry can still continue, thereby increasing the size of the consumed portion of the block of memory. Accordingly, the size difference between the prefetched portion and the consumed portion will reduce below the maximum limit and the block prefetch circuitry may resume generation of the block-instruction-triggered stream of prefetch requests.

In some examples, the throttling circuitry comprises a completion counter, the value of the counter being indicative of an amount of data in the block of memory for which prefetch requests have been generated but which has not yet been consumed by at least one demand memory access. For example, the counter may indicate the number of bytes that has been prefetched by the block prefetch circuitry but not yet consumed by the processing circuitry.

The throttling circuitry may update the completion counter in response to the block prefetch circuitry generating a prefetch request of the block-instruction-triggered stream of prefetch requests and in response to a demand memory access issued by the processing circuitry consuming prefetched data. The amount by which the value of the completion counter is updated does not need to be the same in both cases. In some examples, the amount of data that is prefetched in a single request may be different to the amount of data that is consumed in a single demand memory access by the processing circuitry, so the amount by which the value of the completion counter is updated would vary accordingly.

In some examples, when a flush occurs as described above, any data that has already been prefetched may not be consumed by the processing circuitry. Since the throttling circuitry may continue to track this data with the expectation that it would eventually be consumed, the throttling circuitry would be quicker to pause the block prefetch circuitry unnecessarily, as described above. In other words, the effective amount of data that can be prefetched for a subsequent, i.e. not flushed, block memory instruction is reduced by the amount of prefetched data associated with a flushed instruction. Accordingly, in such examples, the throttling circuitry is configured to reset the completion counter in response to a determination that the value of the completion counter has not been updated for a period of time longer than a predetermined threshold time. For example, this may be determined by monitoring whether the block prefetcher has not generated any prefetch requests during a predetermined time interval and/or monitoring whether the processing circuitry has not generated any demand memory accesses for the prefetched data during a predetermined time interval. This provides a failsafe against the above problem because any prefetched but unconsumed data will be discounted from the amount of data tracked by the completion counter. The predetermined threshold time may, in one particular example, be approximately 1000 cycles, but it will be appreciated that the predetermined threshold time may vary depending on the particular implementation.

The present techniques may be implemented in a data processing apparatus supporting out-of-order processing. For example, the apparatus may be provided with scheduling circuitry to queue the sequence of decoded instructions and schedule the sequence of decoded instructions out of program order depending on, for example, the availability of operands and dependencies between instructions. In some examples, each of a group of two or more block memory instructions can be scheduled in relatively quick succession or even in the same cycle (e.g. in superscalar processors). If this occurs, the respective blocks of memory identified by each block memory instruction would have to be relatively small because otherwise the micro-operations generated by the decoding circuitry could not have been queued simultaneously. It will be appreciated that the meaning of “small” in this context would therefore depend upon on the size of the queue maintained by the scheduling circuitry. Where the processing circuitry issues demand memory access requests to a small block of memory, it is less likely that prefetching for at least some of the block will be timely. In other words, it is more likely that the processing circuitry will have issued all of the demand memory access requests to the block before the prefetch requests have been completed and caused data to be allocated into a cache. Accordingly, the block prefetch circuitry is responsive to the scheduling circuitry scheduling each of the group of two or more block memory instructions within a predetermined time of each other, to generate the block-instruction-triggered stream of prefetch requests for a selected block memory instruction of the group of two or more block memory instructions. The block prefetch circuitry foregoes prefetching for other block memory instructions in the group (i.e. the not-selected block memory instructions) on the assumption that data could not be prefetched quickly enough, thereby saving the power cost of generating the prefetch requests.

In some examples, the selected block memory instruction is the youngest of the group of two or more block memory instructions. Accordingly, the block-instruction-triggered stream of prefetch requests is not generated for the older instructions in the group. This is helpful because it is recognised that, if each of the group of block memory instructions have been scheduled close together enough in time to be within the predetermined time of each other (i.e. they appear within the scheduler queue at a given time), this will be because the older block memory instructions accessed sufficiently small blocks of memory that they completed their block accesses before occupying all entries in the queue. Hence, older block memory instructions are more likely to access a smaller block than the youngest block memory instruction, so to make best use of limited prefetch bandwidth, it is preferable to select the youngest of the group of two or more block memory instructions for prefetching.

In some examples, the decoding circuitry is configured to generate a variable number of micro-operations corresponding to the block memory instruction, the variable number being dependent on a size of the block of memory. In some examples, the block of memory is not confined to the size of any power-of-2 number of bytes. For example, the block of memory may be a non-power-of-2 number of bytes, with the size of the block of memory specified as an operand (either in the instruction itself or by reference to a register). The block location and size may be defined, for example, by the start and end addresses at either end of the block, or an address at one end (start address or end address) together with an indication of the total size. Since the block of memory can be of any arbitrary size, which could be greater than the maximum size than can be processed by the hardware of the processing circuitry in a single pass, the block memory instruction may operate on a selected portion of the block no larger than the total size, update a value (e.g. the size parameter) indicating how much of the block remains, and then branch back to itself if there are bytes in the block that have not yet been operated on. The size of the portion operated on in that pass may be architecturally undefined-different hardware implementations of the processing circuitry may use different approaches, but as the size parameter is updated to account for how much is processed in one pass, the overall result in the end is the same, but different implementations may require different numbers of iterations of micro-operations decoded from the block memory instruction. Accordingly, the decoding circuitry may decode a block memory instruction into a series of micro-operations to perform the memory operation on respective portions of the block of memory. In some examples, one or more further associated block memory instructions specifying the same block of memory may be executed to collectively perform the memory operation across the entire block.

Hence, since the block of memory specified by a block memory instruction can be of any size, and the micro-operations are used to incrementally operate on the entire block of memory, a larger block of memory can cause the decoding circuitry to generate a larger number of micro-operations, whereas a smaller block of memory can cause the decoding circuitry to generate a smaller number of micro-operations.

In some examples, the block memory instruction is either a memory copy instruction or a memory move instruction. These instructions specify a source block of memory to be copied to a destination block of memory. For a memory copy instruction, the source block and the destination block cannot overlap, whereas they can overlap for a memory move instruction. Both types of block memory instruction comprise a load operation and a store operation as the predetermined type of memory operation.

In some examples, the block memory instruction is one of several block memory instructions that are expected (but not required) to occur sequentially in program code. In particular, the block memory instruction comprises a prologue block memory instruction, and in response to the prologue block memory instruction, the decoding circuitry is configured to generate control signals to control the processing circuitry to perform the predetermined memory operation up to a first memory boundary in the block of memory. The prologue block memory instruction may be followed by a main block memory instruction, where the decoding circuitry is configured to generate control signals to control the processing circuitry to perform the predetermined memory operation between the memory boundary and the last memory boundary in the block. The main block memory instruction is capable of branching to itself as many times as necessary for the predetermined memory operation to have been performed until the last memory boundary (given that the hardware may be limited to performing the predetermined memory operation on a certain maximum sized portion of memory per iteration, multiple iterations may be needed for operations on blocks larger than that maximum size). The main block memory instruction may finally be followed by an epilogue block memory instruction, where the decoding circuitry is configured to generate control signals to control the processing circuity to perform the predetermined memory operation between the last memory boundary and the end address of the block, thereby completing the memory operation across the entire block of memory.

Specific examples are now explained with reference to the drawings.

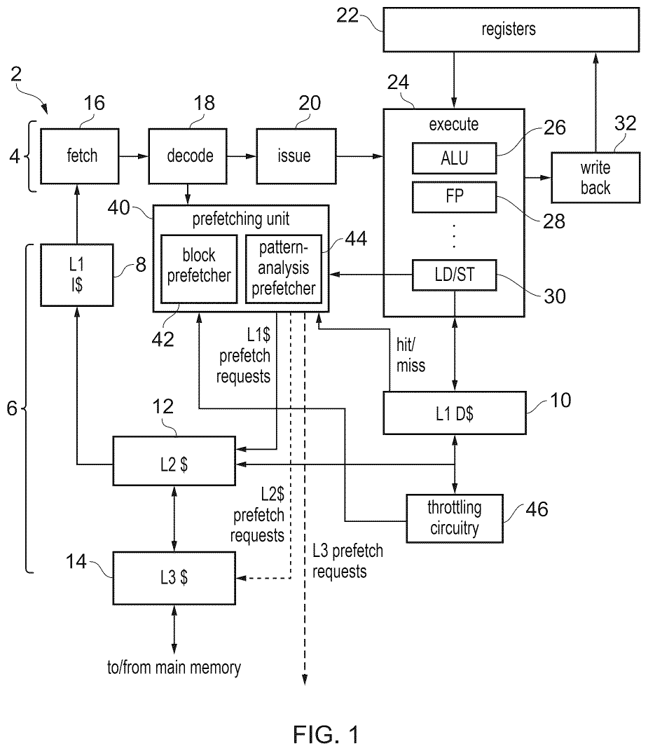

FIG. 1 illustrates an example of a data processing apparatus 2. The apparatus has a processing pipeline 4 for processing program instructions fetched from a memory system 6. The memory system in this example includes a level 1 instruction cache 8, a level 1 data cache 10, a level 2 cache 12 shared between instructions and data, a level 3 cache 14, and main memory which is not illustrated in FIG. 1 but may be accessed in response to requests issued by the processing pipeline 4. It will be appreciated that other examples could have a different arrangement of caches with different numbers of cache levels or with a different hierarchy regarding instruction caching and data caching (e.g. different numbers of levels of cache could be provided for the instruction caches compared to data caches).

The processing pipeline 4 includes a fetch stage 16 for fetching program instructions from the instruction cache 8 or other parts of the memory system 6. The fetched instructions are decoded by a decode stage 18 to identify the types of instructions represented and generate control signals for controlling downstream stages of the pipeline 4 to process the instructions according to the identified instruction types. The decode stage 18 passes the decoded instructions to an issue stage 20 which checks whether any operands required for the instructions are available in registers 22 and issues an instruction for execution when its operands are available (or when it is detected that the operands will be available by the time they reach the execute stage 24). The execute stage 24 includes a number of functional units 26, 28, 30 for performing the processing operations associated with respective types of instructions. For example, in FIG. 1 the execute stage 24 is shown as including an arithmetic/logic unit (ALU) 26 for performing arithmetic operations such as add or multiply and logical operations such as AND, OR, NOT, etc. Also the execute unit includes a floating point unit 28 for performing operations involving operands or results represented as a floating-point number. Also the functional units include a load/store unit 30 for executing load instructions to load data from the memory system 6 to the registers 22 or store instructions to store data from the registers 22 to the memory system 6. Load requests issued by the load/store unit 30 in response to executed load instructions may be referred to as demand load requests. Store requests issued by the load/store unit 30 in response to executed store instructions may be referred to as demand store requests. The demand load requests and demand store requests may be collectively referred to as demand memory access requests. It will be appreciated that the functional units shown in FIG. 1 are just one example, and other examples could have additional types of functional units, or could have multiple functional units of the same type, or may not include all of the types shown in FIG. 1 (e.g. some processors may not have support for floating-point processing). The results of the executed instructions are written back to the registers 22 by a write back stage 32 of the processing pipeline 4.

It will be appreciated that the pipeline shown in FIG. 1 is just one example and other examples could have additional pipeline stages or a different arrangement of pipeline stages. For example, in an out-of-order processor a register rename stage may be provided for mapping architectural registers specified by program instructions to physical registers identifying the registers 22 provided in hardware. Also, it will be appreciated that FIG. 1 does not show all of the components of the data processing apparatus and that other components could also be provided. For example a branch predictor may be provided to predict outcomes of branch instructions so that the fetch stage 16 can fetch subsequent instructions beyond the branch earlier than if waiting for the actual branch outcome. Also a memory management unit could be provided for controlling address translation between virtual addresses specified by the program instructions and physical addresses used by the memory system.

As shown in FIG. 1, the apparatus 2 has a prefetching unit 40 for issuing prefetch requests based on one or more types of prefetch request generation. In this example, the prefetching unit 40 is provided with two types of prefetcher: a block prefetcher 42 and a pattern-analysis prefetcher 44.

The pattern-analysis prefetcher 44 is for analysing patterns of demand target addresses specified by demand memory access requests issued by the load/store unit 30, and detecting address access patterns which can subsequently be used to predict addresses of future memory accesses. For example, the address access patterns may involve stride sequences of addresses where there are a number of addresses separated at regular intervals of a constant stride value. It is also possible to detect other kinds of address access patterns (e.g. a pattern where subsequent accesses target addresses at certain offsets from a start address). The pattern-analysis prefetcher 44 maintains training data representing the observed address access patterns, and uses the training data to generate prefetch requests which are issued to the memory system 6 to request that data is brought into a given level of cache. For example, when a trigger event for a given access pattern is detected (e.g. the trigger event could be program flow reaching a certain program counter address, or a load access to a particular trigger address being detected), the pattern-analysis prefetcher 44 may begin issuing prefetch requests for addresses determined according to that pattern. The prefetch requests are not directly triggered by a particular instruction executed by the pipeline 4, but are issued speculatively with the aim of ensuring that when a subsequent load/store instruction reaches the execute stage 24, the data it requires may already be present within one of the caches, to speed up the processing of that load/store instruction and therefore reduce the likelihood that the pipeline 4 has to be stalled.

The prefetching unit 40 may be able to perform prefetching into a single cache or into multiple caches depending on the prefetch request that is generated. For example, FIG. 1 shows an example of the prefetching unit 40 issuing level 1 cache prefetch requests which are sent to the level 2 cache 12 or downstream memory and request that data from prefetch target addresses is brought into the level 1 data cache 10. Also the prefetcher 40 in this example could also issue level 2 prefetch requests to the level 3 cache 14 or main memory requesting that data from prefetch target addresses is loaded into the level 2 cache 14, and/or level 3 prefetch requests to the main memory requesting that data from prefetch target addresses is loaded into the level 3 cache 14. The level 2 or level 3 prefetch requests may look a longer distance into the future than the level 1 prefetch requests to account for the greater latency expected in obtaining data from main memory into the level 2 or 3 cache 12, 14 compared to obtaining data from a level 2 cache into the level 1 cache 10. In systems using prefetching into multiple levels of cache, prefetches at level 2 or 3 can increase the likelihood that data requested by a level 1 prefetch request or demand access request is already in the level 2 or 3 cache. However, it will be appreciated that the particular caches loaded based on the prefetch requests may vary depending on the particular circuit implementation.

As shown in FIG. 1, as well as the demand target addresses issued by the load/store unit 30, the training of the pattern-analysis prefetcher 44 may also be based on an indication of whether the corresponding demand memory access requests hit or miss in the level 1 data cache 10. The hits/miss indication can be used for filtering the demand target addresses from being included in the training data. This recognises that it is not useful to expend prefetch resource on addresses for which the demand target addresses would anyway hit in the cache. Performance improvement can be greater in focusing prefetcher training on those addresses which, in the absence of prefetching, would have encountered cache misses for the demand access requests. In contrast to the pattern-analysis prefetcher 44, the block prefetcher 42 does not require the accumulation and maintenance of training data based on analysis of patterns of addresses of demand access requests issued by the load/store unit 30. Instead, the block prefetcher 42 is responsive to a block memory instruction being detected by the decode stage 18. The block memory instruction identifies a block of memory to which a predetermined type of memory operation (e.g. a load operation, store operation, or both) is to be performed. The block prefetcher 42 is provided by the decode stage 18 (or a subsequent stage of the pipeline once address operands of the instruction are calculated) with information identifying the block of memory, so that the block prefetcher 42 can start generating a stream of prefetch requests directed to the memory address between a start address and end address of the block of memory. Unlike the pattern-analysis prefetcher 44, the block prefetcher 42 can commence generation of the prefetch requests as soon as the block of memory has been identified, i.e. before any demand memory access requests have actually been generated by the load/store unit 30.

A block memory instruction may be of several different types, such as a memory copy instruction or a memory move instruction. The present techniques will be applicable if a block of memory is incrementally loaded as part of executing the block memory instruction. The block memory instruction may be expected to appear in a sequence of instructions adjacent to other associated block memory instructions directed to the same block of memory. For example, three variants of block memory instruction may be encountered sequentially, including a prologue variant, a main variant and an epilogue variant.

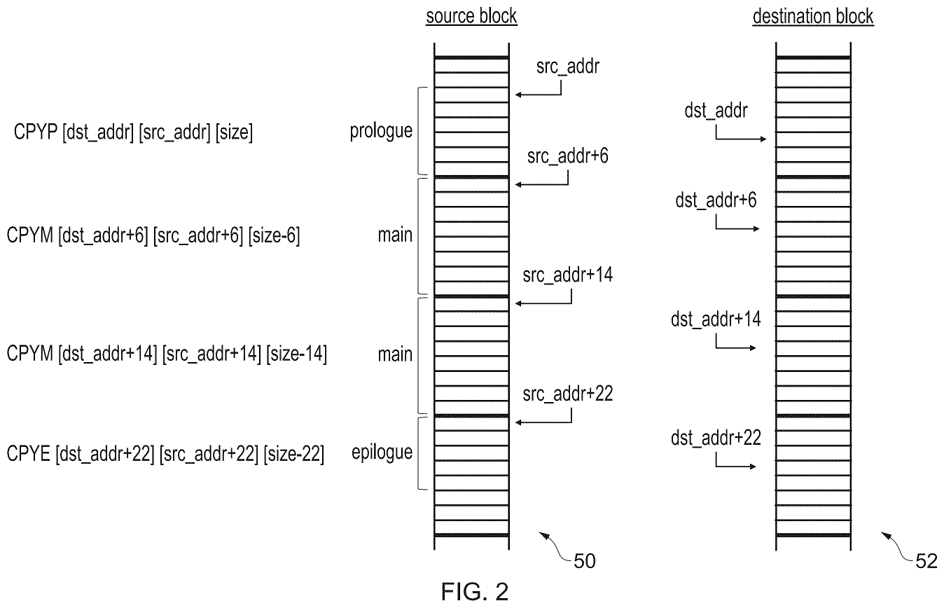

FIG. 2 illustrates how these variants interact with memory and in particular with block(s) of memory identified by the instructions. In this example, a memory copy instruction is used for illustrative purposes, but it will be appreciated that the other block memory instructions can function in a corresponding way. Two blocks of memory are also shown: a source block 50 and a destination block 52, where the memory copy instruction causes data to be copied from the source block 50 to the destination block 52. For each variant, the decode stage 18 generates a plurality of micro-operations to perform the functionality as follows.

A prologue memory copy instruction is encountered comprising: “CPYP [dst_addr] [src_addr][size]”, where CPYP corresponds to the unique opcode of the prologue memory copy instruction, [src_addr] represents the start address of the source block 50, [dst_addr] represents the start address of the destination block 52 and [size] represents the total size of the block of memory, e.g. in bytes. In this example, the source block 50 corresponds the “block of memory” referred to in the claims because processing performance for the memory copy instruction would be likely to benefit more from prefetching data from the source block 50 than from the destination block 52. Unlike generic load instructions or store instructions, the total size of the block of memory specified by a block memory instruction is not constrained to the size of any particular data word or to a power-of-two number of bytes. In the example of FIG. 2, the total size of the block of memory is 27 bytes. When the prologue memory copy instruction is executed by the load/store unit 30, the bytes between the start address [src_addr] and a memory boundary (represented by thicker lines) are copied from the source block 50 to the destination block 52. In this example, the boundaries are shown (for conciseness) at intervals of 8 bytes, but in practice the boundaries for address alignment could be at intervals of any power of 2 number of bytes. Also, in some instances the source block 50 and the destination block 52 may be aligned differently with respect to the alignment boundaries (depending on the particular address operands selected for the memory copy operation). In this example, the prologue operation seeks to improve alignment for the source block in priority to aligning accesses to the destination block, so as the start address [src_addr] is 6 bytes away from the next address alignment boundary, the amount of data loaded from the source block 50 by the prologue memory copy instruction amounts to 6 out of the 27 bytes, ensuring that the next access to part of the block will be aligned to a memory boundary (which tends to make accesses to memory more efficient). However, as the destination start address [dst_addr] is 3 bytes from the next address alignment boundary, storing the data in the destination block 52 may be split between two store requests of 3 bytes each, thereby completing the copy of 6 bytes. It will be appreciated that, if the boundaries were in the same relative position in both blocks 50, 52, then the storage of data in the destination block 52 could be performed in one operation. The size parameter indicating the remaining number of bytes to which the block memory operation (in this example memory copy) may be held in a register and updated after each instruction.

In the program code, the prologue memory copy instruction is followed by a main memory copy instruction comprising: “CPYM [dst_addr+6] [src_addr+6] [size-6]”, where CPYM corresponds to the unique opcode of the main memory copy instruction, [src_addr+6] and [dst_addr+6] represent the addresses in the source block 50 and the destination block 52 up to which the copy has been performed respectively, and [size−6] represents the total size of the block minus the number of bytes that have been copied by the prologue memory copy instruction. The main memory copy instruction is used to perform the copy for the majority of the block. In response to the CPYM instruction, the load/store unit 30 is controlled to copy a block of data no greater than the maximum number of bytes that can be accessed in a single aligned memory access, which may depend on the particular implementation. An aligned memory access is an access in which the target data begins at one address alignment boundary. The main memory copy instruction in this example accesses data between adjacent address alignment boundaries, which in this example amounts to 8 bytes.

At the end of the main memory copy instruction, it can be determined whether the remaining bytes in the block is greater than the maximum number of bytes that can be accessed in a single aligned memory access. If so, then the main memory copy instruction may branch to itself for another iteration. Accordingly, the load/store unit 30 is controlled as though another instruction comprising “CPYM [dst_addr+14] [src_addr+14] [size−14]” had been encountered in the program (although in fact the stored program in memory will only include one instance of the CPYM instruction encountered by decode stage 18, but that instruction is decoded into a variable number of CPYM micro-operations depending on the size of the overall block of memory to be processed). Here, [src_addr+14] and [dst_addr+14] represent the addresses in the source block 50 and the destination block 52 up to which the copy has been performed respectively, and [size−14] represents the total size of the block minus the number of bytes that have been copied by the prologue memory copy instruction and the previous main memory copy instruction. As above, the load/store unit 30 is controlled to copy the maximum number of bytes that can be accessed in a single aligned memory access.

Once the remaining bytes is fewer than that maximum number of bytes that can be accessed in a single memory access, the epilogue memory copy instruction may be used, the epilogue memory copy instruction comprising: “CPYE [dst_addr+22] [src_addr+22] [size−22]”, where CPYE corresponds to the unique opcode of the epilogue memory copy instruction, [src_addr+22] and [dst_addr+22] represent the addresses in the source block 50 and the destination block 52 up to which the copy has been performed respectively, and [size-22] represents the total size of the block minus the number of bytes that have been copied. The epilogue memory copy instruction causes the load/store unit 30 to perform the copy for the remaining bytes in the block, in this example amounting to 5 bytes. The epilogue memory copy instruction may also update the remaining size of the block to verify that it has reached zero, thereby indicating that the memory copy has been completed.

As shown in the example of FIG. 2, each memory copy instruction identifies the source block 50 which is to be copied. As soon as the source block 50 is known, e.g. once [src_addr] and [size] are known from the prologue memory copy instruction, the block prefetcher 42 may commence generating prefetch requests directed to the block.

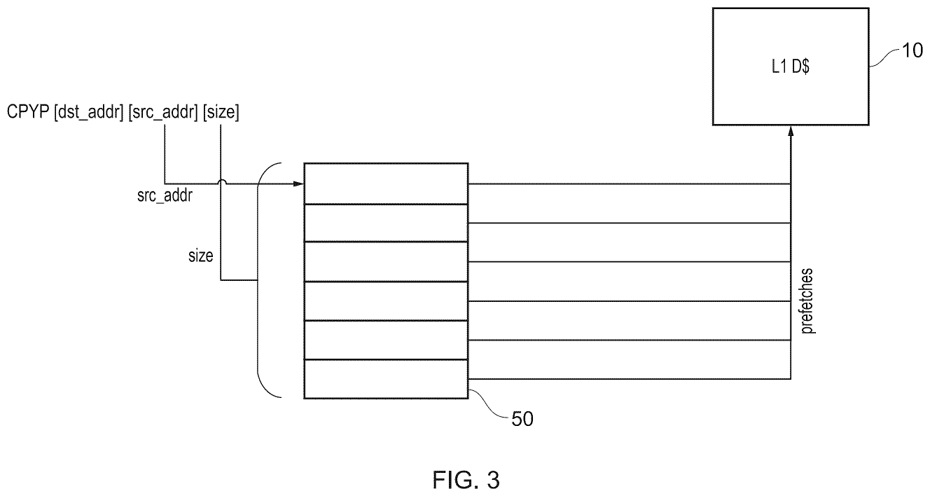

FIG. 3 illustrates an example of a block memory instruction being used to generate a block-instruction-triggered stream of prefetch requests. In FIG. 3, the block of memory 50 is shown in a granularity of cache lines, e.g. 32 bytes. A block memory instruction, e.g. a prologue memory copy instruction, is shown to identify a source block 50 where the start address, src_addr is within the first cache line of the block. The size parameter specified in the prologue memory copy instruction then indicates that the block of memory is encompassed by 6 cache lines in memory. Upon determining that the decode stage 18 has detected the prologue memory copy instruction, the block prefetcher 42 may begin generating a block-instruction triggered stream of prefetch requests directed to the source block 50. In this example, the block-instruction triggered stream of prefetch requests comprises 6 prefetch requests, each directed to a cache line in the source block 50. Each cache line is then brought into the level 1 cache 10, thereby improving the speed at which the load/store unit 30 can perform the copy.

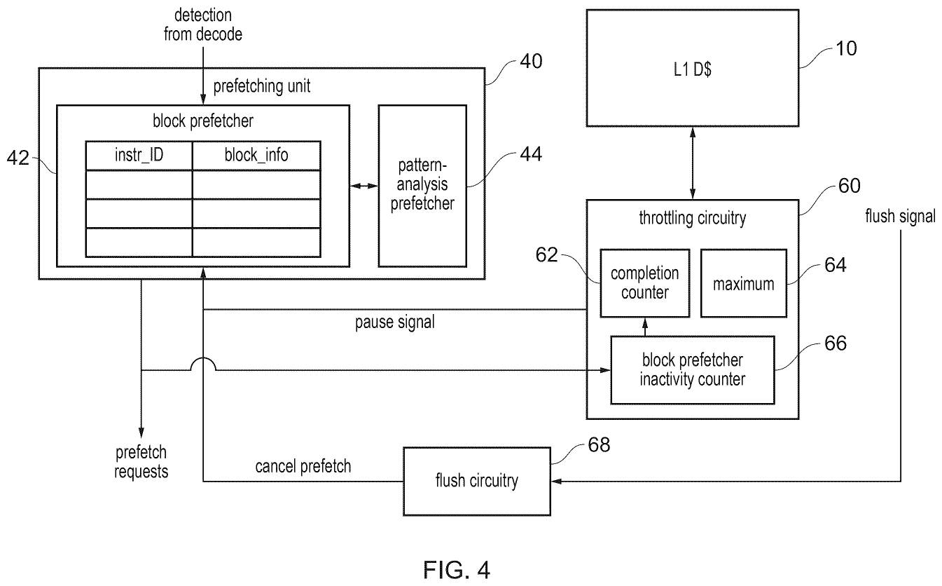

FIG. 4 illustrates an example apparatus incorporating the present techniques. The block prefetcher 42 of this example comprises a block-instruction queue for tracking a plurality of blocks of memory specifies by a plurality of block memory instructions. In this example, the block-instruction queue is capable of tracking three blocks of memory. Each entry of the queue has a field for the instruction ID, which may be a program counter value that corresponds to the block memory instruction. In examples where the block memory instruction (e.g. the prologue instruction CPYP) is followed by additional variants (e.g. main and epilogue variants CPYM, CPYE) the instruction ID may correspond to the first (e.g. prologue) instruction identifying the block. The block information field may contain any information required to identify the block of memory. For example, the block information field may indicate a start address and an end address or a start address and a total size of the block.

In examples where the prefetching unit 40 is provided with both a block prefetcher 42 and a pattern-analysis prefetcher 44, demand memory accesses generated by the load/store unit 30 in respect of a block memory instruction may be excluded from the training data of the pattern-analysis prefetcher 44. Indeed, it will be appreciated that, since prefetching is already expected to be handled by the block prefetcher 42, updating the training data based on these demand memory access would not lead to useful prefetch requests being generated and may waste training resource of the pattern-analysis prefetcher (e.g. entries in a training table) which could better be used for other address access patterns other than the pattern associated with the block memory instructions.

However, in some scenarios a program may include several block memory instructions, each identifying different blocks of memory in relatively quick succession. It is therefore possible for the block-instruction queue to be full, in which case the pattern-analysis prefetcher 44 may be used as a back-up. Specifically, if the block prefetcher 42 does not generate a block-instruction-triggered stream of prefetch requests for a particular block memory instruction, the demand memory access requests in respect of that block memory instruction may be used to update the training data. In this way, some prefetching may still be performed in respect of that block memory instruction.

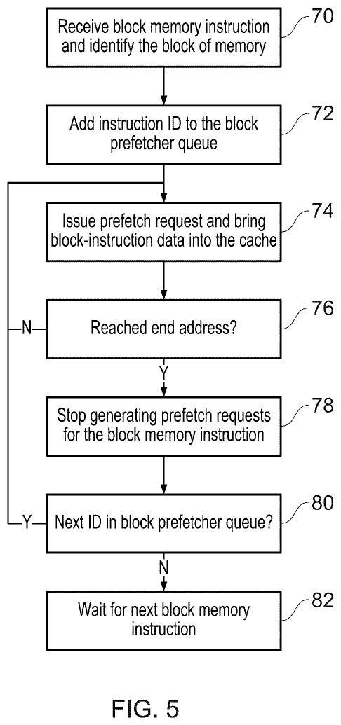

FIG. 5 illustrates a sequence of steps for the generation of the block-instruction-triggered stream of prefetch requests. In step 70, a block memory instruction is received and the block of memory is identified. As above, the block of memory may be identified by providing a memory address at either end of the block or the memory address at one end and a total size of the block. At step 72, an instruction ID corresponding to the block memory instruction is allocated to the block-instruction queue.

At step 74, the block prefetcher 42 issues a prefetch request to bring block-instruction data into the level 1 data cache 10. As described in previous examples, this may involve bringing a cache line containing at least part of the block into the level 1 data cache 10.

At step 76, it is determined whether the block prefetcher has reached the end address. In other words, has the data between the start address and the end address been prefetched by a prefetch request? The end address can be determined from the operands of the prologue instruction CPYP mentioned earlier (e.g. from the source address src_addr marking the start of the source block and the size parameter indicating the total size to be processed in the block memory sequence CPYP, CPYM, CPYE). If the end address has not yet been reached by the already generated sequence of prefetch requests, then there is still some of the block of memory that has not yet been prefetched. Accordingly, the process returns to the step 74 to issue another prefetch request.

If the prefetch request has reached the end address of the block of memory, then the block prefetch can stop generating prefetch requests at step 78. By contrast to the pattern-analysis prefetcher 44 which cannot anticipate when to stop prefetching, the block prefetcher 42 according to the present techniques can stop issuing prefetch requests once the entire block of memory has been prefetched. This brings the advantage of preventing unnecessary data beyond the block of memory from being prefetched into the cache, thereby reducing cache pollution caused by more useful data being evicted due to over-prefetching beyond the end of the block.

At step 80, the block prefetcher 42 determines whether another block memory instruction ID is pending in the block-instruction queue. If so, then the process returns to step 74 to begin issuing prefetch requests directed to a different block of memory. If not, then at step 82 the block prefetcher can wait for the next block memory instruction.

It will be appreciated that in examples that do not include a block-instruction queue, steps 72 and 80 may be skipped.

Returning to FIG. 4, the apparatus is further provided with throttling circuitry 60 to send a pause control signal to cause the block prefetcher 42 to pause the generation of the block-instruction-triggered stream of prefetch requests. The throttling circuitry 60 therefore serves a purpose of controlling how much of the block of memory can be prefetched by the block-prefetcher 42 such that the level 1 cache 10 is not completely filled with data from the block of memory, thereby causing other potentially more useful data to be evicted from the level 1 cache 10. This recognises that for block memory instructions, such as the memory copy instructions shown in FIG. 2, the data loaded by the block memory instruction is often accessed in a “streaming” pattern where the likelihood of reuse of a given item of loaded data by a subsequent load/store operation after the first load to that data is relatively low. As the overall block size may be large, if the prefetcher gets very far ahead of the current demand access, this can risk trashing the existing data that was held in the cache before the block memory operation started (which may be more likely to be useful than some of the data loaded by the block memory instruction). Hence, it may be preferable to limit how much of the cache gets used for data loaded by the block memory operation at a given time.

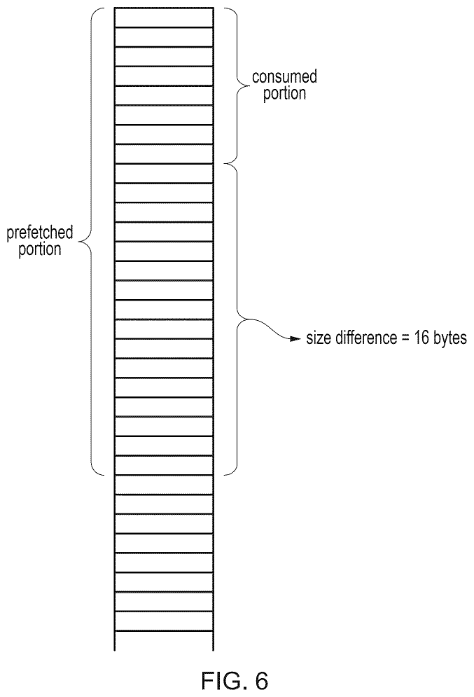

The throttling circuitry 60 therefore tracks the relative size of the portion of data that has been prefetched in response to a given block prefetch sequence and the size of the portion of data that has already been consumed by demand loads after being prefetched. two different portions of the block of memory, as illustrated in FIG. 6. FIG. 6 illustrates an example where the prefetched portion, i.e. that has been targeted by the block-instruction-triggered stream of prefetch requests, is 24 bytes. The consumed portion is where the previously prefetched data has been targeted by a demand memory access by the load/store unit 30 when executing the block memory instruction. For example, referring back to the example of a block memory copy instruction, the consumed portion may represent the portion that has been loaded by the load/store unit 30 for subsequent copying. In FIG. 6, the consumed portion is only 8 bytes, meaning that the size difference between the portions is 24-8 =16 bytes. The throttling circuitry 60 enforces a maximum limit (defined by a maximum limit value 64 shown in FIG. 4) on the size difference, such that the block prefetcher 42 is prevented from prefetching data when a certain amount of previously prefetched data still needs to be consumed. The maximum limit value 64 may be stored in a register or may be defined in the hardware of the throttling circuitry 60.

The throttling circuitry 60 comprises a completion counter 62 for tracking the size difference as described above. In particular, the value of the completion counter 62 may be updated in response to either the block prefetcher 42 generating a prefetch request of the block-instruction-triggered stream of prefetch requests or a demand memory access issued by the load/store unit 30.

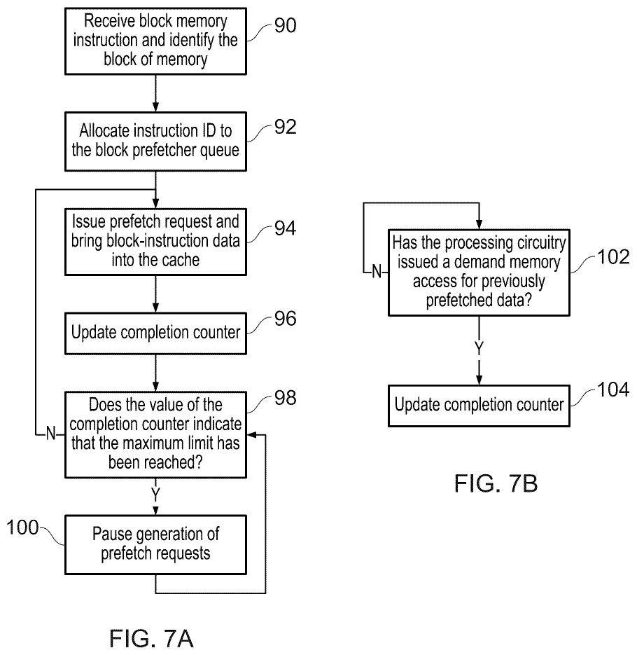

FIG. 7A illustrates a sequence of steps for controlling whether to pause the generation of the block-instruction-triggered stream of prefetch requests. In step 90, a block memory instruction is received and the block of memory is identified. As above, the block of memory may be identified by providing a memory address at either end of the block or the memory address at one end and a total size of the block.

At step 92, an instruction ID corresponding to the block memory instruction is allocated to the block-instruction queue.

At step 94, the block prefetcher 42 issues a prefetch request to bring block-instruction data into the level 1 data cache 10 (or another level of cache). As described in previous examples, this may involve bringing a cache line containing at least part of the block into the cache 10.

At step 96, the completion counter 62 is updated to represent the increase in size of the prefetched portion of data described above. The completion counter 62 may be implemented to count in either direction. For example, in response to a prefetch request being issued, the completion counter 62 may be incremented to indicate an increase in the amount of prefetched data, or alternatively decremented to indicate a decrease in the amount of data that can be prefetched before reaching the maximum limit represented by limit value 64.

At step 98, it is determined whether the value of the completion counter 62 indicates that the maximum limit has been reached. If not, then the generation of the block-instruction-triggered prefetch requests by the block prefetcher 42 may continue.

If the completion counter 62 does indicate that the maximum limit has been reached, then the throttling circuitry 60 outputs a pause signal to cause the block prefetcher 42 to pause generation of prefetch requests at step 100. The throttling circuitry 60 continues to monitor the value of the completion counter 62 for determining whether to resume generation of the prefetch requests.

FIG. 7B illustrates a sequence of steps for updating the value of the completion counter 62, the steps of which may be performed concurrently with the steps of FIG. 7A. At step 102, the throttling circuitry 60 monitors for any demand memory accesses consuming previously prefetched data. For example, the load/store unit 30 may perform a load operation to load the previously prefetched data into one of the registers 22. When a demand memory access is eventually received to consume the previously prefetched data, the completion counter 62 is updated at step 104.

It will be appreciated that the update in step 104 will affect the determination at step 98 of FIG. 7A such that the throttling circuitry 60 may either maintain the pause signal at step 100 (if a pause signal has already been generated) or allow the block prefetcher 42 to resume issuing prefetch requests at step 94.

While not explicitly shown in FIGS. 7A and 7B to avoid repetition, it will be appreciated that issuing of prefetch requests according to FIG. 7A may also be halted once the prefetch requests have reached the end address marking the end of the block, as described earlier for steps 76 and 78 of FIG. 5.

In some examples, a block memory instruction may be encountered by the decode stage 18 but then not actually executed by the execute stage 24. For example, a block memory instruction may be encountered speculatively after incorrectly predicting a branch outcome, and then flushed from the pipeline 4 when the misprediction is detected. Another example is the occurrence of an interrupt while the block memory instruction is between the decode stage 18 and the execute stage 24, also causing the pipeline 4 to be flushed so that the interrupt handling routine can be executed. Returning back to FIG. 4, the apparatus is therefore provided with flush circuitry 68 to receive a pipeline flush signal, e.g. from the execute stage 24, and to cause the block prefetcher 42 to cancel generation of the block-instruction-triggered stream of prefetch requests in respect of the block memory instruction that has been flushed. The flush signal may comprise the block memory instruction ID so that a specific one of the block memory instructions that are queued in the block-instruction queue can be removed, while any other instruction can remain.

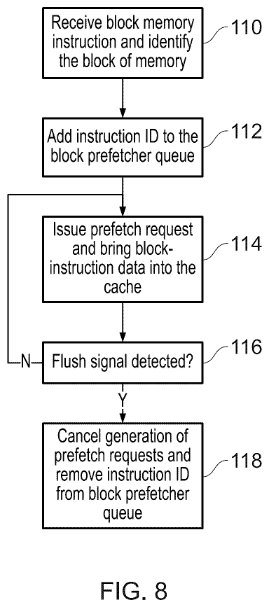

FIG. 8 illustrates a sequence of steps for responding to a flush signal. In step 110, a block memory instruction is received and the block of memory is identified. As above, the block of memory may be identified by providing a memory address at either end of the block or the memory address at one end and a total size of the block.

At step 112, an instruction ID corresponding to the block memory instruction is allocated to the block-instruction queue.

At step 114, the block prefetcher 42 issues a prefetch request to bring block-instruction data into the level 1 data cache 10. As described in previous examples, this may involve bringing a cache line containing at least part of the block into the level 1 data cache 10 or another level of cache.

At step 116 it is determined whether a flush signal indicative of a flush occurring at a point of program flow at or older than the block memory instruction has been detected. If not, then the block prefetcher 42 may continue issuing prefetch requests at step 114. If a flush signal has been detected, then the flush circuitry 68 causes the block prefetcher 42 to cancel the generation of further prefetch requests and to remove the instruction ID from the block-instruction queue.

Since a pipeline flush could occur potentially at any time, it is possible that some data from the block of memory will have been prefetched before the flush signal is received. It will be appreciated that, due to the flush, the memory block instruction will not be executed and hence that previously prefetched data will not be consumed. Accordingly, without the mitigation described below, the throttling circuitry 60 may become locked into a state where the pause signal is being issued to the block prefetcher 42, thereby preventing any prefetch requests from being issued. To resolve this, the throttling circuitry 60 is provided with a block prefetcher inactivity counter 66 to monitor updates to the completion counter 62. The inactivity counter 66 may be incremented at intervals of a given period of time, and may be reset when the completion counter 62 is incremented or decremented. If the value of the completion counter 62 is not updated for a time period longer than a predetermined threshold time (i.e. the block prefetcher inactivity counter 66 overflows or reaches a set threshold), then it can be determined that the throttling circuitry 60 is tracking prefetched data that is not going to be consumed due to the pipeline flush, in which case the completion counter 62 is reset. This therefore allows the block prefetcher 42 to resume issuing prefetch requests.

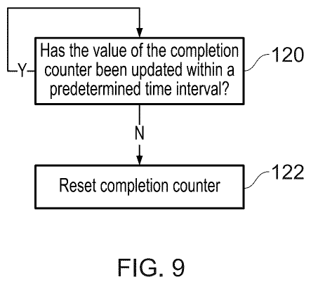

FIG. 9 illustrates a sequence of steps for determining whether to reset the completion counter 62 after a flush signal. At step 120, it is determined whether the completion counter 62 has been updated within a predetermined time interval, for example using the inactivity counter 66 described above. If so, then prefetching of data and/or the consumption of prefetched data is being performed and the throttling circuitry 60 is not locked in a state where a pause signal is being issued to the block prefetcher 42. If, however, there has been no update to the completion counter 62 in a predetermined time interval then it is likely that data has been prefetched unnecessarily and is being tracked by the throttling circuitry 60. The value of the completion counter is therefore reset at step 122.

In some examples, the data processing apparatus 2 may support out-of-order processing, in which instructions are executed by the execute stage 24 in an order that is different from the program order. In such examples, the issue unit 20 may comprise a queue in which operations generated by the decode stage 18 are stored before being scheduled for execution based on dependencies between instructions and the availability of operands.

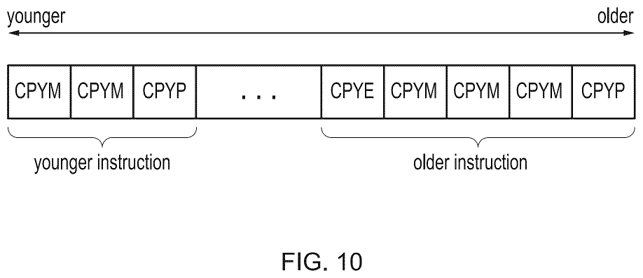

FIG. 10 illustrates an out-of-order window of operations that may be queued and scheduled by the issue unit 20 in a scenario in which the decode stage 18 has detected two memory block instructions (again using the example of a prologue memory copy instruction, CPYP). The issue unit 20 has therefore queued operations corresponding to the prologue, main and epilogue memory copy instructions as described in previous examples. The number of operations corresponding to the main memory copy instruction corresponds to the size of the block of memory. As can be seen in the example of FIG. 10, the block of memory of the older instruction, i.e. the instruction encountered first, is relatively small, which means that there are relatively few instances of the CPYM micro-operations for the older instruction, and therefore micro-operations corresponding to the younger instruction, i.e. the instruction encountered second, can fit in the queue simultaneously. It would be appreciated that in some examples, the decode stage 18 could detect more than two memory block instructions, such that a group of two or more memory block instructions are pending to be issued for execution by the issue unit 20. Similarly, if the queue of the issue unit 20 has sufficient capacity, the micro-operations corresponding to each of the group of two or more memory block instructions can be queued simultaneously. Accordingly, the operations may be scheduled for execution within a predetermined amount of time of each other.

FIG. 10 gives an example of detecting multiple separate block memory sequences being in flight simultaneously based on queuing of micro-operations in an issue queue, but other examples could perform similar detection based on a re-order buffer used to track commitment of instructions executed out of order.

In scenarios where multiple block memory operation sequences are in flight simultaneously, it can be useful for the block prefetcher 42 to prioritise prefetching for one of the block memory instructions (as the circuit overhead that would be needed to enable each simultaneously in-flight sequence to be prefetched by the block prefetcher 42 may not be justified as it may be relatively rare that there is more than one in-flight sequence). Accordingly, the block prefetcher 42 generates a block-instruction-triggered stream of prefetch requests as described above, in respect of a selected block memory instruction, but not for the other block memory instruction(s) that are in-flight simultaneously. The block prefetcher 42 could select any block memory instruction as the selected block memory instruction, but selecting the youngest instruction may increase the likelihood that the prefetch requests are timely. In particular, since the presence of both older and younger block memory sequences in the out-of-order execution window is likely only if the older sequence(s) acts on a relatively short block(s) of memory, the presence of two or more sequences in the same out-of-order execution window is an indication that it is likely that the youngest block memory sequence is likely to act on a larger block of memory than the older block memory sequence(s). Therefore, the advantage of prefetching for the older instruction is lessened. By selecting the youngest instruction, which may be more likely to identify a larger block of memory, it is likely that a greater number of demand loads can be accelerated by prefetching and also considering timeliness of prefetching it is also more likely (for the younger sequence compared to the older sequence) that the prefetched data for at least some of the block will be present in the cache before the load/store unit 30 issues demand memory accesses for the prefetched data.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

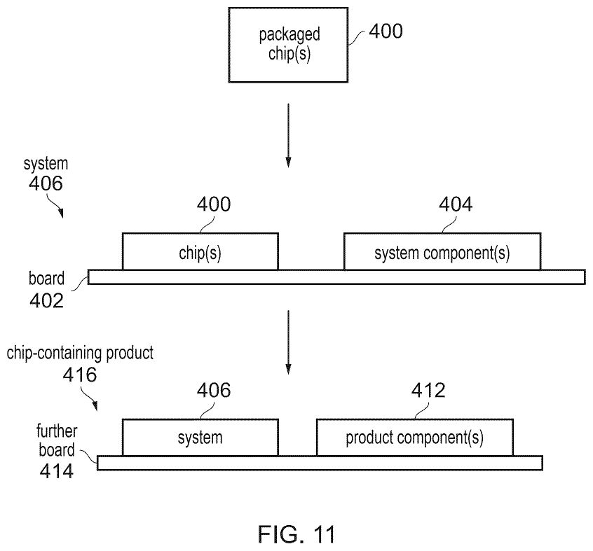

As shown in FIG. 11, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in an apparatus comprising execution circuitry having one or more vector processing units for performing vector operations on vectors comprising multiple data elements. Execution circuitry having X vector processing units each configured to perform vector operations on Y bit wide vectors, with the respective vector processing units operable in parallel, may be said to have an X×Y bit vector datapath. In some embodiments, the execution circuitry is provided having six or more vector processing units. In some embodiments, the execution circuitry is provided having five or fewer vector processing units. In some embodiments, the execution circuitry is provided having two vector processing units (and no more). In some embodiments, the one or more vector processing units are configured to perform vector operations on 128-bit wide vectors. In some embodiments, the execution circuitry has a 2×128 bit vector datapath. Alternatively, in some embodiments the execution circuitry has a 6×128 bit vector datapath.

Concepts described herein may be embodied in an apparatus comprising a level one data (L1D) cache. The L1D cache is a private cache associated with a given processing element (e.g. a central processing unit (CPU) or graphics processing element (GPU)). In a cache hierarchy of multiple caches capable of caching data accessible by load/store operations processed by the given processing element, the L1D cache is a level of cache in the hierarchy which is faster to access than a level two (L2) cache. In some embodiments, the L1 data cache is the fastest to access is the hierarchy, although even faster to access caches, for example, level zero (L0) caches may also be provided. If a load/store operation hits in the L1D cache, it can be serviced with lower latency than if it misses in the L1D cache and is serviced based on data in a subsequent level of cache or in memory. In some embodiments, the L1D cache comprises storage capacity of less than 96 KB, in one example the L1D cache is a 64 KB cache. In some embodiments, the L1D cache comprises storage capacity of greater than or equal to 96 KB, in one example the L1D cache is a 128 KB cache.

Concepts described herein may be embodied in an apparatus comprising a level two (L2) cache. The L2 cache for a given processing element is a level of cache in the cache hierarchy that, among caches capable of holding data accessible to load/store operations, is next fastest to access after the L1D cache. The L2 cache can be looked up in response to a load/store operation missing in the L1D cache or an instruction fetch missing in an L1 instruction cache. In some embodiments, the L2 cache comprises storage capacity of less than 1536 KB (1.5 MB), in one example the L2 cache is a 1024 KB (1 MB) cache. In some embodiments, the L2 cache comprises storage capacity greater than or equal to 1536 KB and less than 2560 KB (2.5 MB), in one example the L2 cache is a 2048 KB (2 MB) cache. In some embodiments, the L2 cache comprises storage capacity greater than or equal to 2560 KB, in one example the L2 cache is a 3072 KB (3 MB) cache. In some embodiments, the L2 cache has a larger storage capacity than the L1D cache.

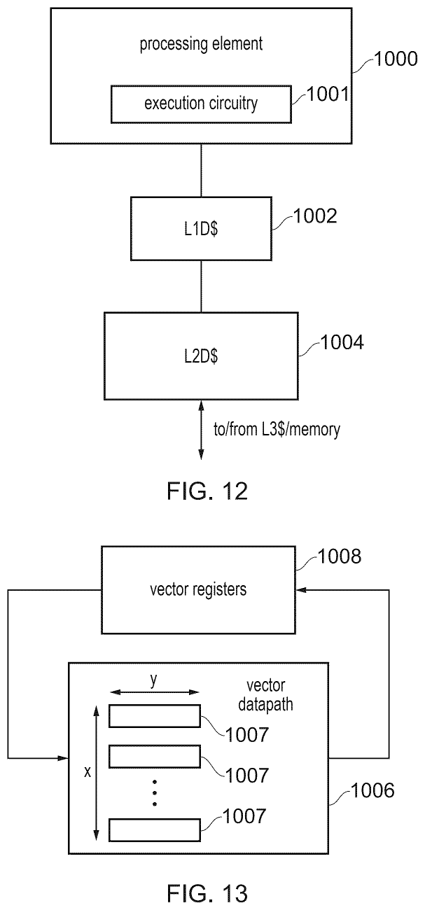

FIG. 12 illustrates an example of an apparatus comprising a processing element 1000 (e.g. a CPU or GPU) comprising execution circuitry 1001 for executing processing operations in response to decoded program instructions. The processing element 1000 has access to a L1D cache 1002 and a L2 cache 1004, which are part of a cache hierarchy of multiple caches for caching data from memory that is accessible by the processing element 1000 in response to load/store operations executed by the execution circuitry 1001. The processing element 1000 may for example comprise the pipeline 4, registers 22 and prefetching unit 40 of FIG. 1, with the execution circuitry 1001 corresponding to the execute stage 24.

FIG. 13 illustrates an example of a vector datapath 1006 that may be provided as part of the execution circuitry 1001 of the processing element 1000, and vector registers 1008 for storing vector operands for processing by the vector datapath 1006. Vector operands read from the vector registers 1008 are processed by the vector datapath 1006 to generate vector results which may be written back to the vector registers 1008. The vector datapath 1006 is an X×Y bit vector datapath, comprising X vector processing units 1007 each configured to perform vector operations on Y bit vectors. The vector registers 1008 may be accessible as Z bit vector registers, where Z can be equal to Y or different to Y. For a vector operation requiring a Z-bit vector operand where Z is greater than Y, the Z-bit vector operand can be processed using two or more vector processing units 1007 operating in parallel on different portions of the Z-bit vector operand in the same cycle and/or using multiple passes through the vector datapath in two or more cycles. For vector operations requiring a Z-bit vector operand where Z is less than Y, a given vector processing unit 1007 can process two or more vectors in parallel.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept. Some examples are set out in the following clauses:

(1) An apparatus comprising:
decoding circuitry to decode instructions defined according to an instruction set architecture, the instruction set architecture supporting a block memory instruction identifying a block of memory to which a predetermined type of memory operation is to be performed;
processing circuitry to perform data processing in response to the decoded instructions; and
block prefetch circuitry configured to generate a prefetch request, the prefetch request comprising a request for data to be prefetched into a cache; in which:
the block prefetch circuitry is configured to:
   determine whether the decoding circuitry has detected the block memory instruction in a sequence of decoded instructions; and
   in response to determining that the decoding circuitry has detected the block memory instruction, generate a block-instruction-triggered stream of prefetch requests, each specifying a memory address between a start address and an end address of the block of memory identified by the block memory instruction.

(2) The apparatus of clause (1), wherein the block prefetch circuitry is configured to generate at least a first prefetch request of the block-instruction-triggered stream of prefetch requests before any demand memory access request has been received from the processing circuitry in response to execution of the block memory instruction.

(3) The apparatus of clause (1) or clause (2), comprising pattern-analysis prefetch circuitry configured to:
maintain training data indicative of an observed pattern of memory accesses;
generate a pattern-triggered stream of prefetch requests based on the training data; and
in response to a block-instruction-triggered stream of prefetch requests being generated in respect of the block memory instruction, the pattern-analysis prefetch circuitry is configured to exclude, from the training data, demand memory access requests received from the processing circuitry in response to execution of the block memory instruction.

(4) The apparatus of any preceding clause, wherein the block prefetch circuitry is configured to stop generating the block-instruction-triggered stream of prefetch requests in response to a flush signal indicative of the block memory instruction, or an associated block memory instruction specifying the block of memory, being flushed.

(5) The apparatus of clause (4), wherein
the block prefetch circuitry comprises a block-instruction queue configured to track a plurality of blocks of memory specified by a plurality of block memory instructions detected by the decoding circuitry, each of the plurality of blocks of memory being associated with an identifier; and
the flush signal comprises the identifier associated with the block of memory.

(6) The apparatus of any preceding clause, comprising throttling circuitry configured to enforce a maximum limit on a size difference between a prefetched portion of the block of memory that has been targeted by the block-instruction-triggered stream of prefetch requests and a consumed portion of the block of memory to which at least one demand memory access has been detected as consuming previously prefetched data.

(7) The apparatus of clause (6) wherein the throttling circuitry is responsive to the size difference reaching the maximum limit to cause the block prefetch circuitry to pause generation of the block-instruction-triggered stream of prefetch requests.

(8) The apparatus of clause (6) or (7), wherein the throttling circuitry comprises a completion counter, the value of the completion counter being indicative of an amount of data in the block of memory for which prefetch requests have been generated but which has not yet been consumed by at least one demand memory access.

(9) The apparatus of clause (8), wherein the throttling circuitry is configured to update the value of the completion counter in response to:
the block prefetch circuitry generating a prefetch request of the block-instruction-triggered stream of prefetch requests; and
a demand memory access issued by the processing circuitry consuming prefetched data.

(10) The apparatus of clauses (8) or (9), wherein the throttling circuitry is configured to reset the completion counter in response to a determination that the value of the completion counter has not been updated for a period of time longer than a predetermined threshold time.

(11) The apparatus of any preceding clause, wherein
the apparatus comprises scheduling circuitry configured to schedule each of a group of two or more block memory instructions detected by the decoding circuitry, the group of two or more block memory instructions comprising the block memory instruction; and
the block prefetch circuitry is responsive to the scheduling circuitry scheduling each of the group of two or more block memory instructions within a predetermined time of each other, to generate the block-instruction-triggered stream of prefetch requests for a selected block memory instruction of the group of two or more block memory instructions.

(12) The apparatus of clause (11), wherein
the selected block memory instruction is the youngest of the group of two or more block memory instructions.

(13) The apparatus of any preceding clause, wherein the decoding circuitry is configured to generate a variable number of micro-operations corresponding to the block memory instruction, the variable number being dependent on a size of the block of memory.

(14) The apparatus of any preceding clause, wherein
the block memory instruction is either a memory copy instruction or a memory move instruction; and
the predetermined type of memory operation comprises a load operation and a store operation.

(15) The apparatus of any preceding clause, wherein the block memory instruction comprises a prologue block memory instruction, and
in response to the prologue block memory instruction, the decoding circuitry is configured to generate control signals to control the processing circuitry to perform the predetermined memory operation up to a memory boundary in the block of memory.

(16) The apparatus of any preceding clause, wherein the processing circuitry comprises a 6×128 bit vector datapath.

(17) A system comprising:
the apparatus of any preceding clause, implemented in at least one packaged chip;
at least one system component;
and a board,
wherein the at least one packaged chip and the at least one system component are assembled on the board.

(18) A chip-containing product comprising the system of clause (17), wherein the system is assembled on a further board with at least one other product component.

(19) A method comprising:
decoding instructions defined according to an instruction set architecture, the instruction set architecture supporting a block memory instruction identifying a block of memory to which a predetermined type of memory operation is to be performed;
performing data processing in response to the decoded instructions;
generating a prefetch request, the prefetch request comprising a request for data to be prefetched into a cache corresponding to an address predicted to be accessed in future; and
in response to detecting the block memory instruction, generating a block-instruction-triggered stream of prefetch requests, each specifying a memory address between a start address and an end address of the block of memory identified by the block memory instruction.

(20) A non-transitory computer-readable medium storing computer-readable code for fabrication of an apparatus comprising:
decoding circuitry to decode instructions defined according to an instruction set architecture, the instruction set architecture supporting a block memory instruction identifying a block of memory to which a predetermined type of memory operation is to be performed;
processing circuitry to perform data processing in response to the decoded instructions; and
block prefetch circuitry configured to generate a prefetch request, the prefetch request comprising a request for data to be prefetched into a cache corresponding to an address predicted to be accessed by the processing circuitry in future; in which:
the block prefetch circuitry is configured to:
   determine whether the decoding circuitry has detected the block memory instruction in a sequence of decoded instructions; and
   in response to determining that the decoding circuitry has detected the block memory instruction, generate a block-instruction-triggered stream of prefetch requests, each specifying a memory address between a start address and an end address of the block of memory identified by the block memory instruction.

In the present application, the words “configured to.” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
decoding circuitry to decode instructions defined according to an instruction set architecture, the instruction set architecture supporting a block memory instruction identifying a block of memory to which a predetermined type of memory operation comprising a load operation and a store operation is to be performed in response to the block memory instruction;
processing circuitry to perform data processing in response to the decoded instructions; and
block prefetch circuitry configured to generate a prefetch request, the prefetch request comprising a request for data to be prefetched into a cache; in which:
the block prefetch circuitry is configured to:
determine whether the decoding circuitry has detected the block memory instruction in a sequence of decoded instructions; and
in response to determining that the decoding circuitry has detected the block memory instruction identifying the block of memory to which the predetermined type of memory operation is to be performed, generate a block-instruction-triggered stream of prefetch requests, each specifying a memory address between a start address and an end address of the block of memory identified by the block memory instruction.

2. The apparatus of claim 1, wherein the block prefetch circuitry is configured to generate at least a first prefetch request of the block-instruction-triggered stream of prefetch requests before any demand memory access request has been received from the processing circuitry in response to execution of the block memory instruction.

3. The apparatus of claim 1, comprising pattern-analysis prefetch circuitry configured to:
maintain training data indicative of an observed pattern of memory accesses;
generate a pattern-triggered stream of prefetch requests based on the training data; and
in response to a block-instruction-triggered stream of prefetch requests being generated in respect of the block memory instruction, the pattern-analysis prefetch circuitry is configured to exclude, from the training data, demand memory access requests received from the processing circuitry in response to execution of the block memory instruction.

4. The apparatus of claim 1, wherein the block prefetch circuitry is configured to stop generating the block-instruction-triggered stream of prefetch requests in response to a flush signal indicative of the block memory instruction, or an associated block memory instruction specifying the block of memory, being flushed.

5. The apparatus of claim 4, wherein
the block prefetch circuitry comprises a block-instruction queue configured to track a plurality of blocks of memory specified by a plurality of block memory instructions detected by the decoding circuitry, each of the plurality of blocks of memory being associated with an identifier; and
the flush signal comprises the identifier associated with the block of memory.

6. The apparatus of claim 1, comprising throttling circuitry configured to enforce a maximum limit on a size difference between a prefetched portion of the block of memory that has been targeted by the block-instruction-triggered stream of prefetch requests and a consumed portion of the block of memory to which at least one demand memory access has been detected as consuming previously prefetched data.

7. The apparatus of claim 6 wherein the throttling circuitry is responsive to the size difference reaching the maximum limit to cause the block prefetch circuitry to pause generation of the block-instruction-triggered stream of prefetch requests.

8. The apparatus of claim 6, wherein the throttling circuitry comprises a completion counter, the value of the completion counter being indicative of an amount of data in the block of memory for which prefetch requests have been generated but which has not yet been consumed by at least one demand memory access.

9. The apparatus of claim 8, wherein the throttling circuitry is configured to update the value of the completion counter in response to:
the block prefetch circuitry generating a prefetch request of the block-instruction-triggered stream of prefetch requests; and
a demand memory access issued by the processing circuitry consuming prefetched data.

10. The apparatus of claim 8, wherein the throttling circuitry is configured to reset the completion counter in response to a determination that the value of the completion counter has not been updated for a period of time longer than a predetermined threshold time.

11. The apparatus of claim 1, wherein
the apparatus comprises scheduling circuitry configured to schedule each of a group of two or more block memory instructions detected by the decoding circuitry, the group of two or more block memory instructions comprising the block memory instruction; and
the block prefetch circuitry is responsive to the scheduling circuitry scheduling each of the group of two or more block memory instructions within a predetermined time of each other, to generate the block-instruction-triggered stream of prefetch requests for a selected block memory instruction of the group of two or more block memory instructions.

12. The apparatus of claim 11, wherein
the selected block memory instruction is the youngest of the group of two or more block memory instructions.

13. The apparatus of claim 1, wherein the decoding circuitry is configured to generate a variable number of micro-operations corresponding to the block memory instruction, the variable number being dependent on a size of the block of memory.

14. The apparatus of claim 1, wherein
the block memory instruction is either a memory copy instruction or a memory move instruction.

15. The apparatus of claim 1, wherein the block memory instruction comprises a prologue block memory instruction, and
in response to the prologue block memory instruction, the decoding circuitry is configured to generate control signals to control the processing circuitry to perform the predetermined memory operations up to a memory boundary in the block of memory.

16. The apparatus of claim 1, wherein the processing circuitry comprises a 6×128 bit vector datapath.

17. A system comprising:
the apparatus of claim 1, implemented in at least one packaged chip;
at least one system component;
and a board,
wherein the at least one packaged chip and the at least one system component are assembled on the board.

18. A chip-containing product comprising the system of claim 17, wherein the system is assembled on a further board with at least one other product component.

19. A method comprising:
decoding instructions defined according to an instruction set architecture, the instruction set architecture supporting a block memory instruction identifying a block of memory to which a predetermined type of memory operation comprising a load operation and a store operation is to be performed in response to the block memory instruction;
performing data processing in response to the decoded instructions;
generating a prefetch request, the prefetch request comprising a request for data to be prefetched into a cache corresponding to an address predicted to be accessed in future; and
in response to detecting the block memory instruction identifying the block of memory to which the predetermined type of memory operation is to be performed, generating a block-instruction-triggered stream of prefetch requests, each specifying a memory address between a start address and an end address of the block of memory identified by the block memory instruction.

20. A non-transitory computer-readable medium storing computer-readable code for fabrication of an apparatus comprising:
decoding circuitry to decode instructions defined according to an instruction set architecture, the instruction set architecture supporting a block memory instruction identifying a block of memory to which a predetermined type of memory operation comprising a load operation and a store operation is to be performed in response to the block memory instruction;
processing circuitry to perform data processing in response to the decoded instructions; and
block prefetch circuitry configured to generate a prefetch request, the prefetch request comprising a request for data to be prefetched into a cache corresponding to an address predicted to be accessed by the processing circuitry in future; in which:
the block prefetch circuitry is configured to:
determine whether the decoding circuitry has detected the block memory instruction in a sequence of decoded instructions; and
in response to determining that the decoding circuitry has detected the block memory instruction identifying the block of memory to which the predetermined type of memory operation is to be performed, generate a block-instruction-triggered stream of prefetch requests, each specifying a memory address between a start address and an end address of the block of memory identified by the block memory instruction.
